(19) United States
(12) Patent Application Publication
(10) Pub. No.: US 2007/0179832 A1
(43) Pub. Date: Aug. 2, 2007

(54) Methods and systems for managing online advertising assets

(76) Inventor: Joshua David Reich, New York, NY (US)

Correspondence Address: JLB CONSULTING, INC.;c/o INTELLEVATE, P.O. BOX 52050, MINNEAPOLIS, MN, 55402, US

(21) Appl. No.: 11/341,882

(22) Filed: Jan. 27, 2006

(51) Int. Cl. G07G 1/00

(52) U.S. Cl. 705/10

(57) ABSTRACT

There are provided methods and systems for managing online advertising assets such as keywords. Taxonomical organizing of assets is used in combination with statistical analytical techniques to enable media/asset managers to straight-forwardly manage large numbers of assets based on the known performance of relatively smaller numbers of assets. Useful cost/performance statistics are developed. A graphical interface format can be used to enable users to navigate large quantities of assets in a friendly graphical format.

### FIELD OF THE INVENTION

The present invention relates generally to online advertising, and more particularly to the use of hierarchical taxonomical structures to quantitatively manage online advertising assets such as keywords.

### BACKGROUND OF THE INVENTION

Advertisers use many types of keyword-based processes for presenting their products and services to users on the Internet. For example, advertisers may employ behaviorally driven banner advertisements, paid inclusion listings and pay-per-click (PPC) listings as part of a concerted media program.

As is known in the art, banner advertisements are small areas of graphics and text included on a web page in the format of a displayed advertisement. Banner advertisements are generally paid for on a cost per impression or cost per click basis.

As is further known in the art, paid inclusion listings are search content that an advertiser provides to a search engine, for a fee, to be included in the search engine index. The search content may include product catalogs and/or other bulk information that may interest consumers. Paid inclusion data feeds are shown in response to a query on a particular keyword, and the advertiser pays a cost for every click on a listing that has been included under a paid inclusion feed.

Again as is known in the art, PPC listings are advertisements that display in response to a keyword query. For instance, if someone enters the phrase “home loan California” into a search engine, a group of home loan vendors may be displayed in a special sponsored area of the search results screen. These sponsors generally participate in an auction to have their listings included in the sponsor section of the search results, and pay an auction-determined price per click for every click-through on the returned listing.

The common thread uniting all of these advertising strategies is the selection and procurement of keywords. The purchase of these keywords results in a cost paid by an advertiser for advertisements that display in response to a consumer search query containing the keywords.

With respect to PPC advertising, in a manner well known in the art, users of the Internet rely in large part on electronic search engines such as Yahoo® and Google® to locate data and to navigate to desired web pages. Many such search engines return two types of results to keyword queries, sponsored results and natural search language results. Sponsored results comprise a link to sponsors or purchasers of the searched keywords, while natural search language results are based on complex and proprietary algorithms developed by each search engine. Because sponsors receive favorable positioning in search engine search results, keywords can comprise an important asset, particularly to Internet businesses.

Sponsors may buy keywords through electronic keyword auctions, commonly known as pay-per-click (PPC) auctions. Yahoo Search Marketing® and Google® are examples of vendors that offer PPC auctions. PPC auctions are dynamic auctions with keywords essentially ‘sold’ to the highest bidder each time that keyword is used to return a search result. Sponsors place keyword ‘bids’ designating a bid price. Each keyword auction site has its own set of unique rules for its auctions.

In operation, each bidder enters a bid, which is the amount they are willing to pay should a customer click on their advertisement in the search results for a keyword at a particular time. For instance, a bidder may be prepared to pay up to $11.03 for a customer who typed “home loan California”, $5.02 for a customer who typed “home loan” and $1.10 for someone who typed in “loan”.

The auction services sort all of the bids that bidders placed for their keywords. The services generally award position 1 in the search results to the highest bid, position 2 to the second highest bid, and so on. The holder of position 1 becomes the first listed result amongst sponsored links returned for the particular keyword. The holder of position 2 returns as the second listed result, and so on. Positions are re-calculated continuously throughout the day and bidders may change their bids at any time. Bidders may submit any bid over the auction minimum, but if the bid is too low they may find themselves placed at position 100 where they never get a click. Thus, there is a trade-off between keeping a bid low enough to maintain profitability and high enough to generate volume.

After each position is awarded, the auctions service determines the final price that each competitor should pay. This amount is usually equal to the bid of the next bidder immediately below. Thus the auction is a second price auction. In terms of price quotes, Yahoo® uses an open bid model where the bids for each position are visible to everyone participating in the auction. In contrast, Google® uses a sealed bid model.

Today over 100,000 advertisers currently participate in PPC auctions. On Google Adwords® alone these auctions generate (US) $1 Billion dollars per year. Yahoo also generates nearly (US) $1 billion from its PPC auctions.

It will thus be seen and understood by the reader that the costs associated with purchasing and managing large quantities of keywords constitutes a significant expense to online advertisers.

Traditionally, these purchases are managed by manually grouping together keywords around arbitrary concepts. For example, a set of 1,000 keywords purchased by a home mortgage lender may be manually grouped into 4 classes: words relating to ‘refinance’, ‘bad credit’, ‘debt consolidation’ and ‘California’. In determining this type of categorization, significant problems arise, among them: i) extensive manual effort is required, and ii) inventory items may be equally appropriate in more than 1 category.

It is known in the art to manage keyword purchase campaign spending using fine-grained automated optimization techniques. Such techniques, in an automated fashion, examine the performance of each keyword and manage on-going budgets accordingly. This is somewhat similar to traditional investment portfolio management techniques, and has at least several significant problems: i) the results of this process are not readily understood by humans, and ii) the optimization technique uses only historical performance data for each inventory item in isolation, and ignores any inter-relationships between similar inventory items.

It will thus be understood by the reader that existing methods and systems for managing portfolios of online keywords exhibit significant problems.

### SUMMARY OF THE INVENTION

The present invention combines tools from graph theory and statistics to develop a quantitative approach to modeling price and performance metrics of advertising inventory. Using the present invention, relatively large quantities of keywords can be effectively managed based on relatively established knowledge regarding relatively small quantities of keywords. The invention enables media managers to explore their data in a hierarchy, so that it is simultaneously easy to get a top-level view of campaign performance, with the ability to drill-down to the level of individual keywords. Using this hierarchical analysis in combination with a graphical user interface, a media manager can view relevant keyword management data in a useful and interactive manner.

In accordance with one embodiment of the present invention, there are provided methods and systems for managing keywords, an exemplary method comprising: identifying a taxonomy for organizing keywords; identifying a plurality of keywords; organizing the plurality of keywords in accordance with the taxonomy; identifying at least one selected keyword organized within the taxonomy; developing data relating to the performance of the at least one selected keyword; and managing the plurality of keywords based upon their position within the taxonomy and the performance of the at least one selected keyword.

In accordance with another embodiment of the present invention, there are provided methods and systems for managing key words, an exemplary method comprising: identifying a taxonomy including a plurality of associated keywords; tracking customer web page activity against the taxonomy; tracking customer conversion activity against the taxonomy; and managing, based upon the steps of tracking customer Web page activity and tracking customer conversion activity, at least one keyword within the taxonomy.

In accordance with yet another embodiment of the present invention, there are provided methods and systems for correlating online customer activities with a pre-established keyword taxonomy, an exemplary method comprising: identifying a taxonomy including a plurality of associated keywords; tracking customer web page activity against the taxonomy to develop a database of historical web page activity data relating viewed web pages to positions in the taxonomy; and tracking customer conversion activity against the taxonomy to develop a database of historical conversion activity relating customer conversions to positions in the taxonomy.

### DESCRIPTION OF THE DRAWING FIGURES

These and other objects, features and advantages of the present invention will be apparent from a consideration of the Detailed Description Of The Invention in consideration with the drawing Figures, in which:

FIG. 1 is a block diagram of a system in accordance with the present invention;

FIG. 2 is a block diagram of the system of FIG. 1 showing functional details of the processing system;

FIG. 3 is a flow chart showing a high-level process in accordance with the present invention;

FIG. 4 is a flow chart showing the details of steps in the process of FIG. 3;

FIG. 5 is a block diagram showing a functional relationship between keywords in accordance with the present invention;

FIG. 6 is a block diagram illustrating the ongoing development of a keyword taxonomy throughout the customer capture and conversion processes; and

FIG. 7 is a flow chart showing the details of the keyword management process of FIG. 3.

### DETAILED DESCRIPTION OF THE INVENTION

As used herein, the terms “example,” “exemplary,” “illustration,” and variants thereof are illustrative in nature and not limiting.

As used herein, the terms “keyword,” “assets,” and “keyword assets,” and variants thereon, are used interchangeably to identify network-published assets, containing keywords, that are purchased by advertisers for selection by customers through publishers in order to drive customer traffic to advertisers. Examples of such assets include: keywords, banner advertisements, pop-ups, tag-alongs and email based creative content.

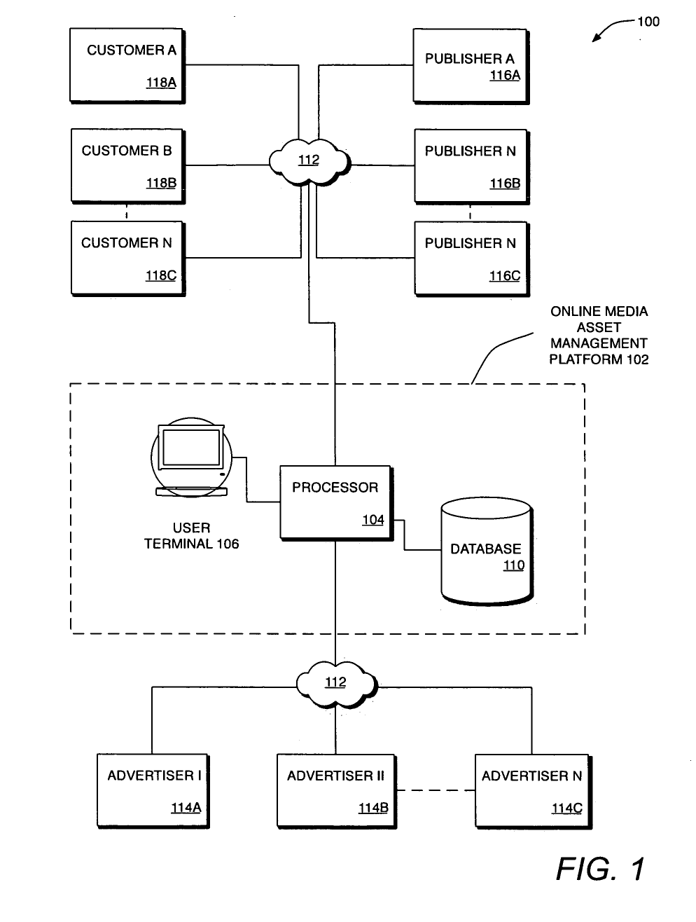

With reference now to FIG. 1, there is shown a system 100 including an online media asset management platform 102. Online media asset management platform 102 is seen to include a processor 104 connected to a user terminal 106 and a database 110. The processor 104 is connected through conventional network connections, for example the Internet as shown at 112, to communicate with a variety of external parties.

Continuing with reference to FIG. 1, processor 104 is seen to be connected to communicate with a plurality of advertisers 114, three of which are indicated at 114A, 114B and 114C. Similarly, processor 104 is seen to be connected to communicate with a plurality of publishers 116, three of which are indicated at 116A, 116B and 116C and a plurality of customers, three of which are indicated at 118A, 118B and 118C. The publishers are connected so as to serve advertisements through network 112 to customers 118. The interactions of advertisers 114, publishers 116 and customers 118 are described in further detail herein below.

It will be appreciated that media management platform 102 can comprise conventional system components situated and programmed to perform the described elements of the present invention. Processor 104 can comprise, for example, a conventional network server with a conventional microprocessor and operating system. User terminal 106 can comprise a conventional keyboard and display device. Database 110 can comprise a conventional arrangement of memory, for example an appropriate combination of semiconductor, magnetic and optical storage. It will be understood by the reader that while online media asset management platform 102 has been shown in simplified form. In actual construction it can comprise one of many known configurations, for example a centralized system and/or a decentralized system comprising the described components in multiple and/or decentralized configurations.

Publishers 116 comprise online content publishers, many of which are known to the reader. Advertisers 114 comprise online advertisers, for example retail advertisers, who desire to purchase online media for the purpose of placing advertisements through publishers 116 on network 112 for display to customers 118. It will be understood by the reader that in many instances a single entity can comprise both a publisher and an advertiser. Amazon.com™, for example, is a well-known online retailer who both publishes content pages including advertising as well as purchases advertising from others.

Like elements throughout the Figures are indicated by like reference numbers.

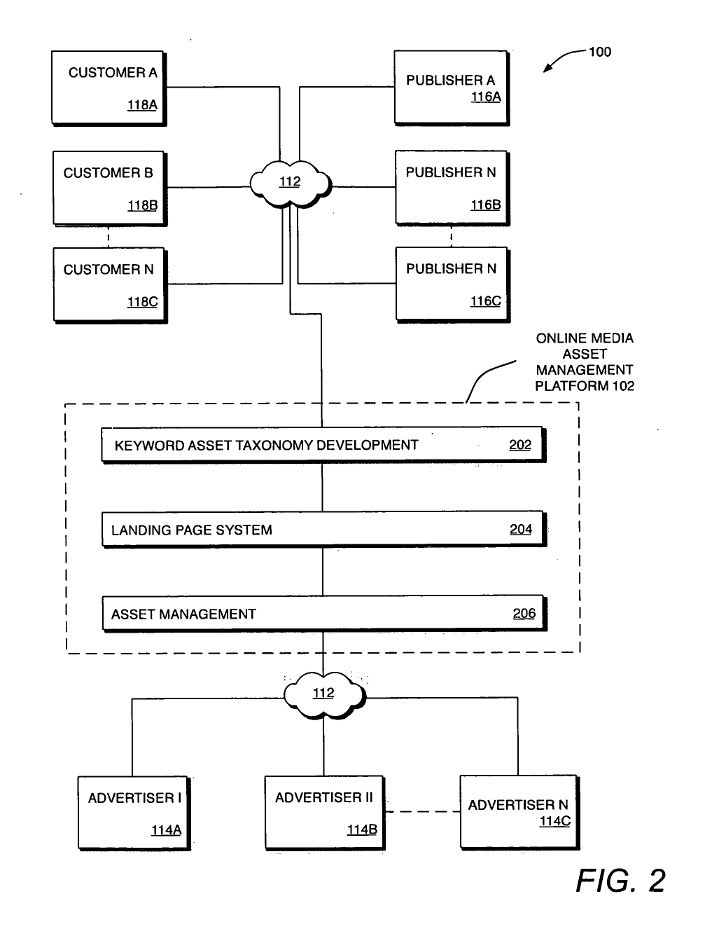

With reference now to FIG. 2, system 100 of FIG. 1 is shown with asset management platform 102 displayed in block diagram form to include three functional processes, a keyword asset taxonomy development function 202, a landing page system and associated monitoring functions 204 and an asset management function 206. As will be described in detail herein below, keyword asset taxonomy development function 202 operates to classify keywords in accordance with one or more useful taxonomies. Landing page system function 204 operates to capture customer 118 clicks on purchased keywords to develop a database of historical conversion data, while asset management function 206 operates to manage the keyword assets in accordance with the taxonomy and historical conversion data.

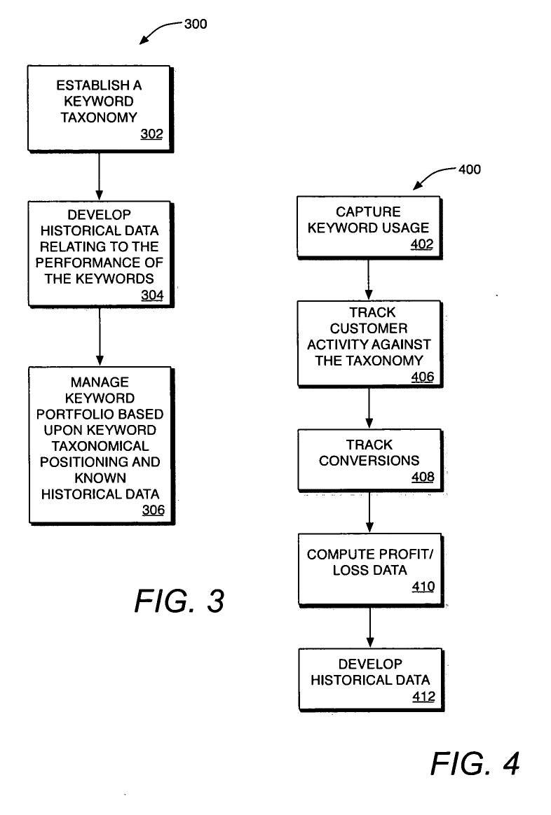

With reference now to FIG. 3, there is shown a process 300 describing at a high level a process for managing online media assets, using system 102, in accordance with the present invention. Initially, process 300 includes the establishment of a keyword taxonomy (step 302)—a keyword classification useful for the practice of the present invention. In accordance with the present invention, the keyword taxonomy will be used in combination with performance data to make decisions regarding the purchase and value of large quantities of keywords based upon their taxonomical relationship to other keywords. A taxonomy useful with the present invention must thus classify keywords into categories of relationships useful for predicting their performance as online media assets. This use of a taxonomy replaces the manual process of a human operator idiosyncratically grouping keywords together.

The open directory keyword taxonomy available through Netscape® at Internet website www.dmoz.org is one taxonomy useable to practice the present invention. This database contains a list of Web sites arranged in a hierarchical taxonomy. A useful keyword taxonomy is straight-forwardly built by using the taxonomically arranged Web sites in the public database. Selected Web sites are then scanned for keyword content. A database of keywords is established and organized, each keyword sorted and assigned to one or more of the locations in the taxonomy of topics.

Another useful taxonomy is the SIC (Standard Industrial Classification) code, a well-known classification of industry business segments, sorted topically by business category with each category identified by a 4-digit code. As noted above, the characteristics of a useful taxonomy in accordance with the present invention include: i) a systematic approach to categorizing topics, ii) a computer—readable format and iii) a logical manner in which the taxonomy inventory can be mapped to topics. Numerous other useful taxonomies will now be apparent to the reader.

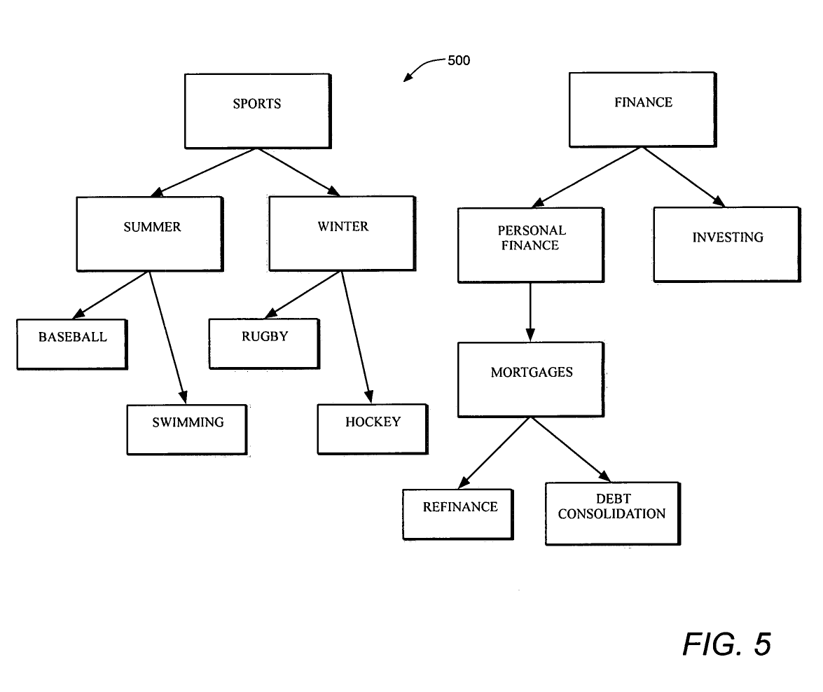

With reference to FIG. 5, a graphical illustration of a keyword taxonomy 500 is shown, developed using one of the above-described sources or processes. For purposes of illustration, only two exemplary taxonomy categories are shown and described. A first category, sports, includes two sub categories: summer sports and winter sports. A second category, finance, also includes two sub categories: personal finance and investing. It will be understood by the reader that in actual practice virtually unlimited numbers of categories, subcategories and keywords can be used.

Within category “Finance”, sub-category “personal finance”, there is seen to be the sub-category “mortgages” having two keywords: “debt consolidation” and “refinance”. Within category “sports”, sub category “winter”, there are seen to be two keywords: “hockey” and “rugby”. For the purposes of the present invention, the relationship between keywords is determined by the graphical ‘distance’ between keywords in the taxonomical categories. For example, “hockey” is seen to be a distance of four steps from the keyword “swimming,” counting between each adjacent keyword: hockey—winter (1)—sports (2)—summer (3)—swimming (4). In contrast, the keyword “investing” is seen to be a distance of three steps from the keyword “mortgages”: Investing—finance (1)—personal finance (2)—mortgages (3). As will be seen from the description below, these taxonomical: “distances” between keywords are used, directly and/or in combination with statistical analysis, in making decisions with respect to the purchase and/or valuation of the various keywords. Generally, the invention contemplates that the closer the distance between two keywords within the selected taxonomy, the more likely the keywords are to provide the same business result.

With reference back to FIG. 3, subsequent to the establishment of a keyword taxonomy, there is developed historical data relating to the performance of actual keywords within the taxonomy (step 304). With reference now to FIG. 4, there is shown a process 400 for developing such historical data.

For purposes of description, it is assumed that the taxonomy has been established and that certain keywords have been selected and purchased for use. It is further assumed that the cost associated with the purchase of these keywords is both known and stored by system 102. As noted above, these keywords can take the form of various types of Internet assets, each designed generally to drive customer traffic from a publisher Web site to an advertiser Web site.

Initially, the purchased keywords of known cost are captured (step 402), for example by landing page system 204 of asset management platform 102. Landing page functionality is well known in the art; a landing page functions to receiving incoming traffic, and particularly to transmit information to a customer browser, the traffic resulting from customer selection of a keyword. Landing pages are typically used both to inform the customer about the products or services and to allow a company to qualify a customer for a particular product or service. Landing pages may contain user-fillable forms by which users can express their desire for particular products or services.

As noted above, advertising inventory, described here in the form of keywords owned by platform 102 and published by publishers 116 for viewing by customer 118, are typically used to drive customer traffic to an advertiser 114 Web site. The function and intended goal of the receiving system, in the present invention online media asset management platform 102, is to facilitate the conversion of the incoming traffic into a profitable transaction, such as a product purchase or an expression of intent, which can then be sold as a direct marketing lead to an advertiser 114. A customer arriving at a landing page or other web page is considered to ‘convert’ when they complete any such revenue generating process.

Considering different types of landing pages available within landing page system 204, as a customer 118 navigates their way through the landing pages, they will traverse Web pages or ‘gestural touch points’ that are either automatically or manually categorized in the above-described, pre-established keyword taxonomy (step 404), thereby connecting each landing page with a position in the keyword taxonomy. The process of landing page classification can either be performed manually, or via algorithms that determine key words within the page and then associate those keywords with the existing taxonomy. These processes of categorization allows the operator of asset management platform 102 to identify the relationship between topics which drive customer traffic to the landing pages and the topics of interest recognizable through the customer selection of landing page links and options as customers learn more about the offered products and services. These expressions can be discerned from, for example, the generation and display of forms to be completed by the customer, telephone calls initiated to the customer, the provision to the customer of Web pages having relevant items for sale, and other conversion events as will now be apparent to the reader.

Customer navigation through landing pages is thus tracked and recorded in association with the taxonomy of the various keywords and/or other assets associated with the selected pages (step 406). For example, upon arriving at a landing page after clicking on a keyword, the customer may perform a search on the landing page. That search term is then checked against the keyword taxonomy to reveal further information about the desires of the user. After completing a search, the user may select a particular search result. This result page may be coded in the taxonomy. Additionally, the user may choose to complete a form, the information contained within that form also being cross-referenced against the taxonomy.

Thus, using the initially developed keyword taxonomy various types of customer activities are tracked against that taxonomy to develop a rich dataset that can be used to correlate the advertising (search activity) that attracted the user with the actual user performance (landing page activity), all the activities correlated by the appropriate keywords against the keyword taxonomy.

For example, the described process may reveal that a number of customers who originally search for “iPod Install” are primarily owners of a particular brand of car. This would establish a link between the ‘music player’ category and the ‘automotive’ category within the taxonomy. Such non-obvious associations may allow for targeting of direct marketing campaigns through less expensive channels than those of the prior art.

Subsequent to the above-described activities, conversions are tracked (step 408). For example, if a user signs up for more information about a home loan, this may be considered a conversion. Conversions may happen on web sites not under the control of advertisers or publishers, so the operator of platform 102 must additionally track conversion performance. This is typically accomplished through the use of cookies, or other digital foot-printing techniques, by which the operator of platform 102 can tie the conversion of an individual browser to the advertising that led them to the conversion.

Continuing again with reference to FIG. 4, conversions are tracked in the manner described above, and the cost of those conversions considered with the above—described cost of the keywords, so as to calculate the profit and loss on each individual keyword (step 410). Combining both spend and revenue figures at each point in the taxonomical keyword hierarchy, relevant keyword performance metrics are determined. These metrics can include: Cost Per Acquisition (the spend required on keyword purchase and transform process to convert a customer), Revenue Per Conversion (the revenue obtained from a conversion), Return on Investment (revenue/cost). In addition statistical information such as the distribution of these calculated values can be tracked, enabling the performance of statistical tests to infer whether or not particular data points are statistically significant. In this manner, historical data, including both customer activity and conversions as tracked against the keyword taxonomy, can be developed (step 412), and used by system 102 to manage asset inventory as is further described below.

With reference now back to FIG. 3, subsequent to the development of the historical data, this historical data is used by system 102, in combination with the taxonomical position of selected keywords relative to other keywords, to manage the keyword inventory (step 306). By tracking both cost and revenue in the same hierarchy it can be determined not only what is spent for a particular piece (or group) of inventory, but moreover what the break-even threshold is. By using statistical techniques inferences are made about the hypothetical performance of inventory yet to purchase in the manner described below.

For example, given the volatile nature of keyword pricing, arising from the underlying auction dynamics, if an advertiser 114 and/or the operator of platform 102 wishes to purchase a top ranked keyword, for example, over a fixed period of time—then one is exposed to market pricing risks. As neither Google® nor Yahoo® provide historical price series, market participants must rely on their own estimations of such risk. In financial markets future expected volatility is typically modeled as some function of historical volatility, yet if one does not have access to historical information, future volatility is difficult to model. By using a robust and consistent taxonomy for classifying keywords in accordance with the present invention, techniques are made available for overcoming this problem. For example, with reference to FIG. 5, if one has been exposed to the auction environment for the ‘refinance’ keyword then one should be able to estimate the future volatility of the price and traffic levels driven by that inventory. However, if one is now considering purchasing the ‘debt consolidation’ keyword, but has no historical pricing information, in accordance with a key feature and benefit of the present invention, one can now use the taxonomy derived distance measure to approximate future movements in the price of the ‘debt consolidation’ phrase using historically observed prices for the ‘refinance’ keyword.

A variety of statistical techniques may be employed to model keyword volatility and value using the above-described taxonomical relationships. For example, a simple linear model for the volatility of inventory price can be built using the sum of the volatilities of inventory weighted by the taxonomical distance from the inventory of interest. This may be expressed as:

$$E ( {σ}_{j} ) = α + {\sum }_{i} {w}_{d} {σ}_{i} ,$$

where d represents the distance from inventory item i to the item of interest, j.
This model, and more complex variants, may be trained from a small initial set of observations and can be improved upon over time as new data becomes available. Other statistical analysis and modeling techniques will now be apparent to the reader.

In addition to providing insight into risk exposure, the inventory taxonomy can also be used to identify underpriced inventory. For example, we may find that a cluster of inventory tends to perform well and within that cluster there may exist a handful of inventory items that are priced lower than what is expected for its implied conversion performance.

Beyond statistical approaches, which benefit from the consistency from taxonomical classification, contrasted against traditional ad hoc approaches, similar benefits are afforded to managers who are responsible for advertising inventory management. In the past, it was near impossible to compare campaigns managed by different individuals or agencies, as each party would take a different approach to classifying inventory. Using the processes of the present invention, the selection and valuation of keywords is no longer left to the subjective discretion of the individual, and as such disparate campaigns can be compared along side each other and strengths and weaknesses can be easily identified. When keyword selection, risk and valuation are determined in accordance with the processes of the present invention, managers are able to identify new inventory opportunities and are able to model hypothetical performance, given the historical performance of related inventories categories.

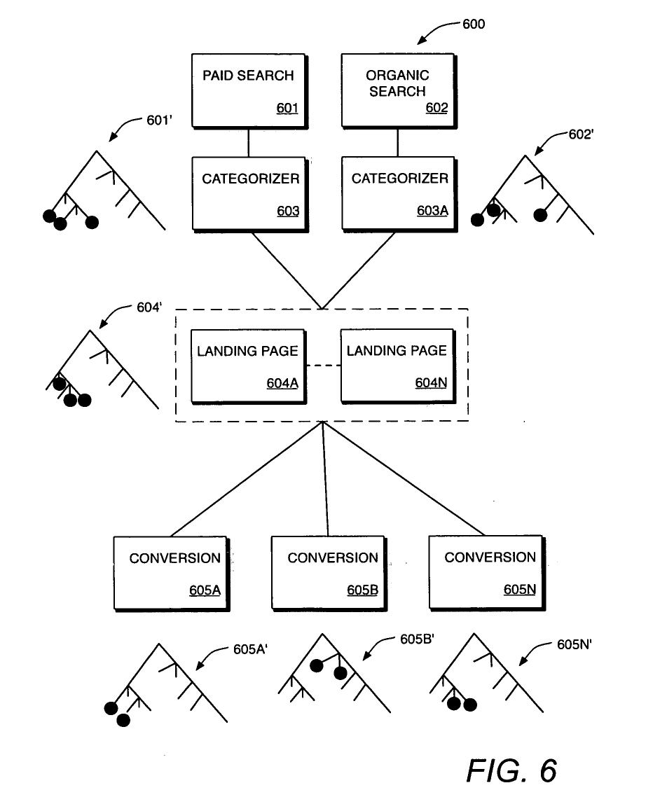

With reference now to FIG. 6 there is shown how the above-described keyword taxonomy categorization process can be used along the entire customer 118 acquisition chain. Various steps in the chain include associated state graphs or trees, illustrated by a prime, showing the categorization of keywords within a taxonomy for the corresponding process step. In step 601 it is shown how paid search terms can be associated with particular categories 601′ within the taxonomy. Similarly, organic search terms 602, those arising from natural search results, can be categorized 602′ within the taxonomy, on the fly. These categorizations are performed by a categorizer process, indicated at 603, 603A, within landing page system 204. The comparison between the performance of paid and organic terms, in relation to where the terms lie within the taxonomy provides useful insight for advertising inventory management.

There are shown landing pages 604A-N, which have either been manually taxonomically categorized, or alternatively taxonomically categorized using automatic keyword extraction from the content of the landing pages, as shown at 604′. When used in combination with the paid and organic category trees, inventory managers can identify possible mismatches and opportunities between the keyword taxonomy topics associated with their traffic sources and the keyword taxonomy topics that the landing pages are intended to cater to. The process of inventory management is described in further detail herein below. At 605, there is shown how a number of conversion opportunities A-N (such as purchases, or points for signing up for additional information via email) can also be taxonomically categorized, 605′ A-N. By including these revenue generating steps within the category tree, managers can identify which topics are most profitable or where there is the least risk faced in expanding inventory purchases.

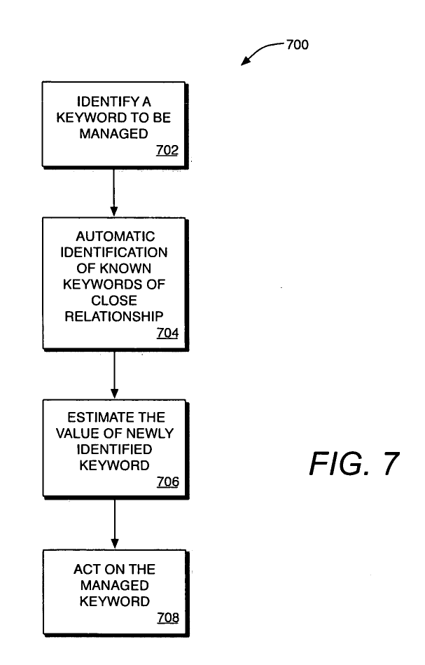

With reference now to FIG. 7, there is shown a process 700 for using known historical asset performance data to manage the asset portfolio. More particularly, one or more keywords to be managed are identified (step 702). Using the above described taxonomical relationships, keywords of known close relationship are identified (step 704); that is keywords that are in relatively close relationship step-wise and/or statistically, taxonomically as described above. Using the above described historical data and statistical analysis techniques, there is estimated the value of the newly identified keyword(s) or inventory category(s) (steps 706), and appropriate keyword management actions are taking based on that historical data and management process (step 708). Such management actions can include, for example: purchase/no purchase decisions, valuation, timing of purchase(s), and others as will be apparent to the reader.

As described above, the invention enables media managers to explore their data in a hierarchy, so that it is simultaneously easy to get both a top-level view of campaign performance along with the ability to drill-down to the level of individual keywords, as desired. By attaching the above system to a graphical user interface, either as a stand alone application, or a web based application, this data can be used by media managers in an interactive manner. Thus, keyword portfolio managers, such as operators of platform 102, can not only gain insight into current and historical activities, but are also able to estimate the performance of various future campaigns.

There have thus been provided new and improved methods and systems for managing online advertising assets such as keywords. The invention uses taxonomical organizing of assets in combination with statistical analytical techniques to enable media/asset managers to straight-forwardly manage large numbers of assets based on the known performance of relatively smaller numbers of assets. The invention enables the development of useful cost/performance statistics. The invention can be implemented in a graphical interface format so as to enable users to navigate large quantities of assets in a friendly graphical format. The invention has application in the field of advertising and particularly in the field of online electronic advertising.

While the invention has been shown and described with respect to particular embodiments, it is not thus limited. Numerous modifications, changes and improvements within the scope of the invention will now be apparent to the reader.

What is claimed is:

1. A method operable on a computer for managing keywords, comprising:
identifying a taxonomy for organizing keywords;
identifying a plurality of keywords;
organizing the plurality of keywords in accordance with the taxonomy;
identifying at least one selected keyword organized within the taxonomy;
developing data relating to the performance of the at least one selected keyword; and
managing the plurality of keywords based upon their position within the taxonomy and the performance of the at least one selected keyword.

2. The method of claim 1 wherein the keywords are online advertising keywords.

3. The method of claim 2 wherein the data relating to performance includes cost-effectiveness data.

4. The method of claim 2 wherein the step of managing the data includes the steps of:
determining whether to purchase the keyword; and
determining, if the keyword is purchased, a price for the keyword.

5. A system for managing keywords, comprising:
means for identifying a taxonomy for organizing keywords;
means for identifying a plurality of keywords;
means for organizing the plurality of keywords in accordance with the taxonomy;
means for identifying at least one selected keyword organized within the taxonomy;
means for developing data relating to the performance of the at least one selected keyword; and
means for managing the plurality of keywords based upon their position within the taxonomy and the performance of the at least one selected keyword.

6. A method operable on a computer for managing keywords, comprising:
identifying a taxonomy including a plurality of associated keywords;
tracking customer web page activity against the taxonomy;
tracking customer conversion activity against the taxonomy; and
managing, based upon the steps of tracking customer Web page activity and tracking customer conversion activity, at least one keyword within the taxonomy.

7. The method of claim 6 wherein the step of tracking customer web page activity against the taxonomy includes developing a body of historical web page activity data relating keywords used to select viewed web pages to the taxonomy.

8. The method of claim 8 wherein the step of tracking customer conversion activity against the taxonomy includes developing a body of historical conversion data relating keywords used to initiate customer conversion activity to the taxonomy.

9. The method of claim 6 wherein the step of tracking customer web page activity against the taxonomy includes the steps of:
tracking at least one web page viewed by a customer; and
determining an association between the at least one web page and a position in the taxonomy.

10. The method of claim 7 wherein the step of determining an association between the at least one web page and a position in the taxonomy includes at least one of the group comprising automatically determining the association between the at least one web page and the position in the taxonomy and manually determining the association between the at least one web page and the position in the taxonomy.

11. The method of claim 8 wherein the step of managing at least one keyword within the taxonomy includes the steps of:
identifying a first keyword in a first position in the taxonomy, the first position having at least one of historical web page activity data and historical conversion data associated therewith;
identifying a second keyword in a second position in the taxonomy, the second position having little or no historical web page activity data and little or no historical conversion data associated therewith; and
managing the second keyword based on the relative positions of the first position and the second position in the taxonomy.

12. The method of claim 11 wherein at least one of the historical conversion data and historical web page data includes cost-effectiveness data.

13. The method of claim 11 wherein the step of managing the second keyword includes the steps of:
determining whether to purchase the second keyword; and
determining, if the second keyword is purchased, a price for the second keyword.

14. The method of claim 6 wherein the keywords are online advertising keywords.

15. A system for managing keywords, comprising:
a keyword taxonomy including a plurality of associated keywords;
a landing page system for tracking customer web page activity against the taxonomy;
the landing page system further operative to track customer conversion activity against the taxonomy; and
an asset management system responsive to the tracked customer Web page activity and tracked customer conversion activity, for managing at least one keyword within the taxonomy.

16. A method operable on a computer for correlating online customer activities with a pre-established keyword taxonomy, comprising:
identifying a taxonomy including a plurality of associated keywords;
tracking customer web page activity against the taxonomy to develop a database of historical web page activity data relating viewed web pages to positions in the taxonomy; and
tracking customer conversion activity against the taxonomy to develop a database of historical conversion activity relating customer conversions to positions in the taxonomy.

17. The method of claim 16 wherein the step of tracking customer web page activity against the taxonomy includes the steps of:
determining a keyword used to select a viewed web page; and
determining, based upon the keyword, a position within the taxonomy to which the viewed web page corresponds.

18. The method of claim 17 wherein the step of determining the content of a viewed web page includes at least one of the group comprising automatically tracking web page activity against the taxonomy and manually tracking web page activity against the taxonomy.

19. The method of claim 16 wherein the step of tracking customer conversion activity against the taxonomy includes the step of relating the conversion to a keyword associated with the conversion.

20. A system for correlating online customer activities with a pre-established keyword taxonomy, comprising:
a memory storing software instructions; and
a processor connected to the memory and responsive to the software instructions to perform the steps of:
identifying a taxonomy including a plurality of associated keywords;
tracking customer web page activity against the taxonomy to develop a database of historical web page activity data relating viewed web pages to positions in the taxonomy; and
tracking customer conversion activity against the taxonomy to develop a database of historical conversion activity relating customer conversions to positions in the taxonomy.
